(19) United States
(12) Patent Application Publication
(10) Pub. No.: US 2006/0082284 A1
(43) Pub. Date: Apr. 20, 2006

(54) Display and array substrate

(76) Inventor: Makoto Shibusawa, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/216,019

(22) Filed: Sep. 1, 2005

(30) Foreign Application Priority Data
Oct. 15, 2004 (JP) 2004-301622

(51) Int. Cl. H05B 33/08; H05B 33/02

(52) U.S. Cl. 313/500; 313/505

(57) ABSTRACT

A display includes an insulating substrate, an auxiliary line placed on a main surface of the insulating substrate, an insulating underlayer covering the auxiliary line and the main surface of the insulating substrate and provided with a through-hole which communicates with the auxiliary line, pixel electrodes arranged on the insulating underlayer and surrounding an opening of the through-hole, photo-active layers each covering the pixel electrode and each including a light-emission layer, and a light-transmissive common electrode covering the photo-active layers and electrically connected to the auxiliary line via the through-hole.

### CROSS-REFERENCE TO RELATED APPLICATIONS

This application is based upon and claims the benefit of priority from prior Japanese Patent Application No. 2004-301622, filed Oct. 15, 2004, the entire contents of which are incorporated herein by reference.

### BACKGROUND OF THE INVENTION

1. Field of the Invention

The present invention relates to a display such as an organic EL display, and an array substrate for use in it.

2. Description of the Related Art

Organic EL displays have a structure in which an organic layer including a light-emitting layer is interposed between a pair of electrodes. In active matrix organic EL displays, one of the electrodes that is close to the underlayer is used as a pixel electrode, and the other electrode is used as a common electrode.

Organic EL displays can employ a bottom emission structure in which light emitted by organic EL elements is extracted from the underlayer side, or a top emission structure in which light is extracted from the opposite side. In the top emission organic EL displays, even if thin-film transistors (hereinafter referred to as “TFTs”) or wires are arranged at positions that overlap organic EL elements in the thickness direction, the light emitted from the organic EL elements is not blocked off by them, unlike the bottom emission organic EL displays. Therefore, the top emission organic EL displays can achieve the same luminance as the bottom emission organic EL displays, using a lower current density than the latter displays.

However, in the top emission organic EL displays, the common electrode must have light-transmission property. In general, conductive materials having a high light transmittance, such as indium tin oxide (ITO), have a higher specific resistance than metals such as Al. For instance, when the thickness of electrodes is set to several hundred nanometers, the sheet resistance of an ITO electrode is 100 times or more that of an Al electrode. This being so, in the top emission organic EL displays, in particular, in organic EL displays with a display area having a diagonal dimension exceeding 10 inches, a great difference in electric potential may well occur between the peripheral and central portions of the common electrode.

In light of the above, Jpn. Pat. Appln. KOKAI Publication No. 2002-318556 discloses a structure in which pixel electrodes and auxiliary lines are arranged on the same insulating layer, and a common electrode is electrically connected to the auxiliary lines in a display area. This structure can reduce the potential difference between the peripheral and central portions of the common electrode.

### BRIEF SUMMARY OF THE INVENTION

An object of the invention is to suppress display unevenness in a display area of an active matrix display.

According to a first aspect of the present invention, there is provided a display comprising an insulating substrate, an auxiliary line disposed on a main surface of the insulating substrate, an insulating underlayer covering the auxiliary line and the main surface of the insulating substrate and provided with a first through-hole which communicates with the auxiliary line, pixel electrodes disposed on the insulating underlayer and surrounding an opening of the first through-hole, photo-active layers each covering the pixel electrode and each including a light-emission layer, and a light-transmissive common electrode covering the photo-active layers and electrically connected to the auxiliary line via the first through-hole.

According to a second aspect of the present invention, there is provided an array substrate comprising an insulating substrate, an auxiliary line disposed on a main surface of the insulating substrate, an insulating underlayer covering the auxiliary line and the main surface of the insulating substrate and provided with a first through-hole which communicates with the auxiliary line, pixel electrodes disposed on the insulating underlayer and surrounding an opening of the first through-hole.

### BRIEF DESCRIPTION OF THE SEVERAL VIEWS OF THE DRAWING

FIG. 1 is a plan view schematically showing a display according to a first embodiment of the invention;

FIG. 2 is an enlarged plan view showing a display panel of the display shown in FIG. 1;

FIG. 3 is a sectional view taken along a line III-III of the display panel shown in FIG. 2;

FIG. 4 is a sectional view taken along a line IV-IV of the display panel shown in FIG. 2;

FIG. 5 is an enlarged plan view showing a display panel of an organic EL display according to a second embodiment of the invention;

FIG. 6 is a sectional view taken along a line VI-VI of the display panel shown in FIG. 5; and

FIG. 7 is a plan view schematically showing an example of a structure which may be employed in the display panel according to the second embodiment.

### DETAILED DESCRIPTION OF THE INVENTION

Embodiments of the present invention will be described below in detail with reference to the accompanying drawing. The same reference numerals denote constituent elements having the same or similar functions throughout the drawing, and repetitive description thereof will be omitted.

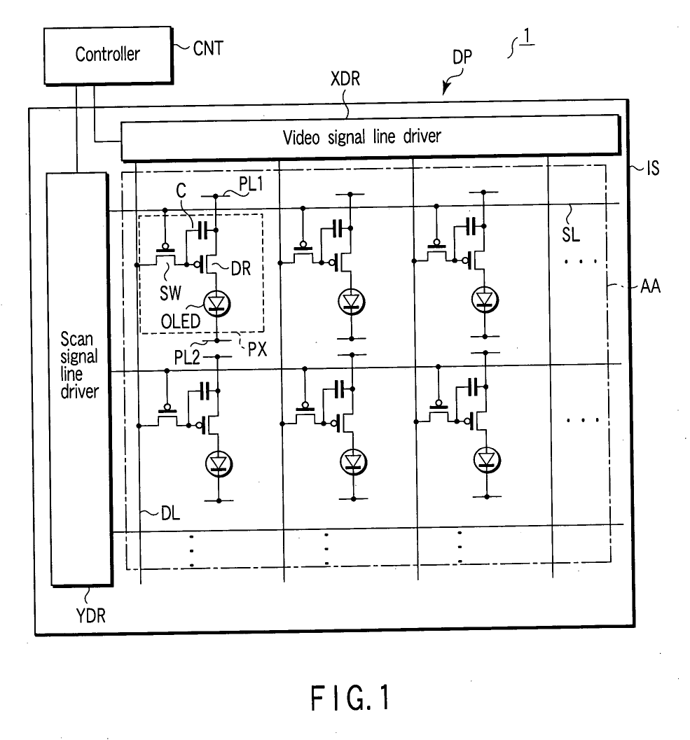

FIG. 1 is a plan view schematically showing an organic EL display according to a first embodiment of the invention. The display 1 is a top emission organic EL display that employs an active matrix driving method, and includes a display panel DP and controller CNT.

The display panel DP includes an insulating substrate IS such as a glass substrate, and pixels PX arranged in a matrix on the major surface of the substrate IS. The pixels PX define a display area AA on the major surface of the substrate IS. On the area outside the display area AA, i.e., the peripheral area, a scan signal line driver YDR and video signal line driver XDR are located as driving circuits.

Each pixel PX includes a drive control element DR, capacitor C, switch SW and organic EL element OLED. In this embodiment, the drive control element DR, capacitor C, switch SW form a pixel circuit.

The drive control element DR includes first and second terminals and a control terminal. In this embodiment, the drive control element DR is a p-channel field-effect transistor (TFT), and has its source (i.e., the first terminal) connected to a power supply line PL1, and its drain (i.e., the second terminal) connected to the organic EL element OLED. The drive control element DR operates so that a current corresponding to the potential difference between the gate (i.e., the control terminal) and the source (i.e., the first terminal) flows between the source and drain thereof.

One terminal (first electrode E1) of the capacitor C is connected to the control terminal of the drive control element DR. The other terminal (second electrode E2) of the capacitor C is typically connected to a constant current terminal, for example, the power supply line PL1. While the switch SW is open, the capacitor C maintains substantially constant the potential difference between the control terminal and source (first terminal) of the drive control element DR.

The switch SW includes an input terminal, output terminal and control terminal. In this embodiment, the switch SW is a p-channel TFT, and has its drain (i.e., input terminal) connected to the video signal line driver XDR via a video signal line DL, and its source (i.e., output terminal) connected to the control terminal of the drive control element DR. Further, the gate (i.e., control terminal) of the switch SW is connected to the scan signal line driver DR via a scan signal line SL.

The organic EL element OLED is connected between the drain (i.e., second terminal) of the drive control element DR and a power supply line PL2 as an auxiliary line. The power supply lines PL1 and PL2 are set at different potentials. In this embodiment, the power supply line PL1 is set at a higher potential than the power supply line PL2.

The controller CNT includes a printed circuit board provided outside the display panel DP, and various elements mounted thereon, and controls the operations of the scan signal line driver YDR and video signal line driver XDR. Specifically, the controller CNT receives a digital video signal and synchronization signal from an external circuit, and generates a vertical scan control signal for controlling vertical scan timing, and a horizontal scan control signal for controlling horizontal scan timing, based on the synchronization signal. The controller CNT supplies the generated vertical and horizontal scan control signals to the scan signal line driver YDR and video signal line driver XDR, respectively, and supplies a digital video signal to the video signal line driver XDR in synchronism with the vertical and horizontal scan timing.

The video signal line driver XDR converts digital video signals into analog signals for a horizontal scan period under the control of the horizontal scan control signals, and simultaneously supplies the converted video signals to video signal lines DL. In this embodiment, the video signal line driver XDR supplies video signals as voltage signals to the video signal lines DL.

The scan signal line driver YDR sequentially supplies scan signals for controlling the switching operation of the switches SW to scan signal lines SL under the control of the vertical scan control signals.

Referring to FIGS. 2 to 4, the display panel DP of the organic EL display 1 will be described in more detail.

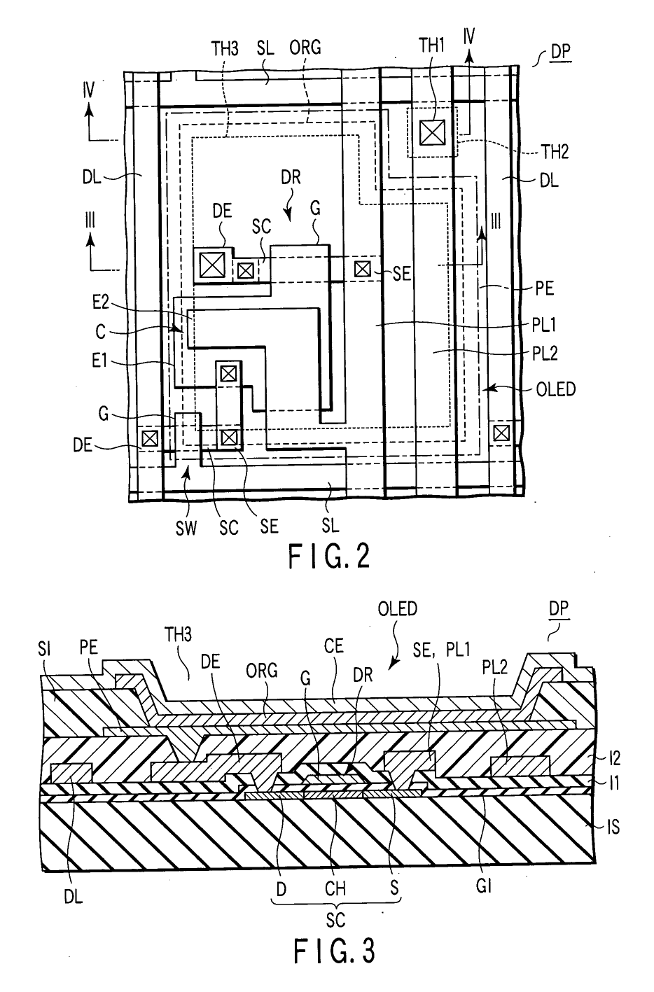

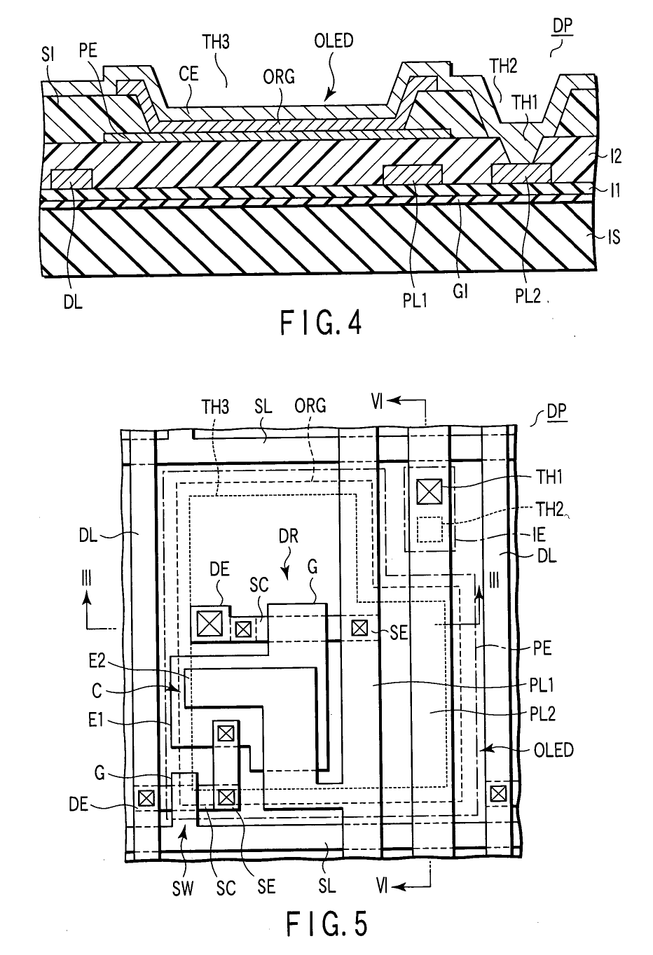

FIG. 2 is an enlarged plan view showing the display panel DP of the display 1 shown in FIG. 1. FIG. 3 is a sectional view taken along line III-III of the display panel DP shown in FIG. 2. FIG. 4 is a sectional view taken along line IV-IV of the display panel DP shown in FIG. 2.

As shown in FIGS. 2 and 3, patterned semiconductor layers SC are arranged on the major surface of the insulating substrate IS. These patterned semiconductor layers SC are made of, for example, polysilicon.

In each semiconductor layer SC, the source S and drain D of a TFT are formed spaced apart from each other. The region CH between the source S and drain D of the semiconductor layer SC is used as a channel.

As shown in FIGS. 3 and 4, a gate insulator GI is formed on the semiconductor layers SC, and a first conductor pattern and insulating film I1 are sequentially formed on the gate insulator GI. The first conductor pattern is used as, for example, the gate G of the TFT, the first electrode E1 of the capacitor C, the scan signal line SL, and interconnections connecting them. Further, the insulating film I1 is used as the interlayer insulating film and the dielectric layer of the capacitor C.

A second conductor pattern is formed on the insulating film I1. The second conductor pattern is used as, for example, a source electrode SE, a drain electrode DE, the second electrode E2 of the capacitor C, the video signal line DL, the power supply lines PL1 and PL2, and interconnections connecting them. The source electrode SE and drain electrode DE are connected to the source S and drain D of the TFT, respectively, at positions corresponding to through-holes formed in the insulating films GI and I1.

An insulating film I2 and third conductor pattern are sequentially formed on the second conductor pattern and insulating film I1. The insulating film I2 is used as a passivation film and/or flattening layer. The third conductor pattern is used as the pixel electrode PE of each organic EL element OLED. In this embodiment, the pixel electrode PE has a light-reflection property.

When the pixel electrode PE is formed by deposition and etching, a material having a lower etching rate than that of the pixel electrode PE is typically used as the material of the power supply lines. For instance, if the pixel electrode PE is made of Mo, Ti, W or an alloy thereof, the power supply line PL2 may be made of an Al-based material.

A through-hole that communicates with the pixel electrode PE connected to the drain electrode DE is formed in the insulating film I2 for every pixel PX. The sidewalls and bottom of each through-hole is coated with the corresponding pixel electrode PE, whereby each pixel electrode PE is connected to the drain D of the drive control element DR via the drain electrode DE.

Another through-hole TH1 that communicates with the power supply line PL2 is formed in the insulating film I2 for every pixel PX. The through-hole TH1 is forward tapered so that the diameter of the hole TH1 is gradually reduced from the surface of the insulating film I2 toward the underlayer side.

A partition insulating layer SI is formed on the insulating film I2. The partition insulating layer SI is, for example, an organic insulating layer or a laminate structure of an inorganic insulating layer and organic insulating layer.

In the partition insulating layer SI, a forward-tapered through-hole TH2 and forward-tapered through-hole TH3 are formed at the positions of each through-hole TH1 and pixel electrode PE, respectively. The diameter of the through-hole TH2 on the side of the insulating film I2 is larger than that of the through-hole TH1 on the side of the partition insulating layer SI. Namely, the upper surface of the insulating layer I2, which is located around the upper edge of the through-hole TH1 close to the partition insulating layer SI, is exposed to the space within the through-hole TH2.

In the through-hole TH3 of the partition insulating layer SI, the pixel electrode PE is covered with an organic layer ORG (i.e., a photo-active layer) including a light-emitting layer. The light-emitting layer is, for example, a thin film containing a luminescent organic compound that emits red, green, or blue light. In addition to the light-emitting layer, the organic layer ORG may include, for example, a hole injection layer, hole transporting layer, electron transporting layer, and electron injection layer, etc. Each layer forming the organic layer ORG can be formed by mask deposition or ink jet.

A light-transmissible common electrode CE made of, for example, ITO is formed over the partition insulating layer SI and organic layer ORG. The common electrode CE covers the sidewalls of the through-holes TH1 and TH2, the area of the upper surface of the insulating layer I2 exposed to the space within the through-hole TH2, and the area of the upper surface of the power supply line PL2 exposed to the space within the through-hole TH1. As a result, the common electrode CE is connected to the power supply line PL2. Each organic EL element OLED is formed of the pixel electrode PE, organic layer ORG and common electrode CE.

In the above organic EL display 1, the substrate IS, pixel electrodes PE and the members interposed therebetween form an array substrate. As shown in FIG. 1, this array substrate may further include the scan signal line driver YDR and video signal line driver XDR.

The organic EL display 1 constructed as above is operated in the following manner.

A scan signal for closing the switch SW (i.e., for setting the switch in the ON state) is sequentially supplied to the scan signal lines SL, and a voltage signal as a video signal is supplied to each video signal line DL in a write period during which the switches SW are closed. As a result, the gate G (i.e., control terminal) of the drive control element DR is set to the potential corresponding to the video signal. The write period is terminated when the switches SW are opened (i.e., set in the OFF state).

In a light-emitting period subsequent to the write period, the potential of the gate as the control terminal of the drive control element DR is maintained as it is by the capacitor C. In this period, a current corresponding to the voltage between the gate and source of the drive control element DR is supplied to the organic EL element OLED, and the organic EL element OLED emits light at a luminance corresponding to the current. The emission period continues until the next write period starts.

As described above, in the organic EL display 1, the power supply lines PL2 are arranged in the display area AA, and the common electrode is electrically connected to the power supply line PL2 for every pixel PX. This prevents the potential of the common electrode CE from varying in the display area.

It is desirable that the power supply lines PL2 be made of a material that has a sufficiently lower resistance than the transparent conductive film forming the common electrode CE, specifically, made of a conductive material having a specific resistance of 11×10⁻⁶ Ω·cm or less. The use of a low-resistance material can further reduce the variations in the potential of the common electrode in the display area.

Further, in the organic EL display 1, the power supply lines PL2 for supplying power to the common electrode CE are located below the pixel electrodes PE. This structure enables the number of pixel electrodes PE per unit area to be increased, compared to the case where the power supply lines PL2 and the pixel electrodes PE are arranged on the same layer. Accordingly, a sufficient luminance can be achieved using a lower current density than in the latter case. In other words, brighter display and/or a longer life can be realized.

In addition, in the organic EL display 1, the through-holes TH1 and TH2 are forward tapered, and each portion of the upper surface of the insulating layer I2 surrounding an opening of the through-hole TH1 on the side of the partition insulating layer SI is exposed to the space within the through-hole TH2. Namely, a sidewall of a through-hole formed by connecting the through-holes TH1 and TH2 to each other includes a stepped portion in the depth direction.

If there is no such stepped portion, the common electrode CE may well have a discontinuous portion in the through-holes TH1 and TH2, since a laminate structure including the insulating layer I2 and partition insulating layer SI is relatively thick. In contrast, if the above-mentioned stepped portion exists, the discontinuous portion does not easily be formed.

The power supply lines PL2 can be formed in the same process as the power supply lines PL1 and video signal lines DL. Furthermore, the through-holes TH1 can be formed in the same process as the through-holes for connecting the pixel electrodes PE to the source electrodes SE of the drive control elements DR, and the through-holes TH2 can be formed in the same process as the through-holes in the partition insulating layer SI at positions of the pixel electrodes PE. As a result, without increasing the number of manufacturing processes, the sheet resistance of the common electrode CE can be reduced, potential variations in the common electrode CE can be suppressed, and display unevenness can be sufficiently suppressed.

A second embodiment of the invention will now be described.

The second embodiment is similar to the first embodiment except for the manner of connection between the power supply lines PL2 and the common electrode CE. Therefore, in the second embodiment, the manner of connection therebetween will be mainly described.

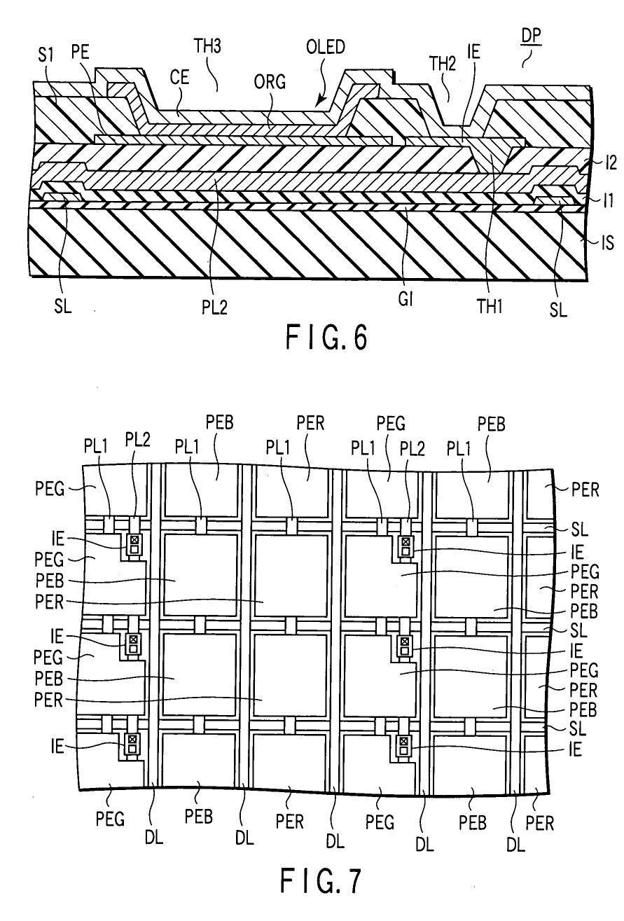

FIG. 5 is an enlarged plan view showing a display panel DP of an organic EL display according to the second embodiment of the invention. FIG. 6 is a sectional view taken along a line VI-VI of the display panel shown in FIG. 5. Note that a sectional view taken along a line III-III of the display panel shown in FIG. 5 is similar to the view shown in FIG. 3.

In this display panel DP, the power supply lines PL2 are arranged in the display area AA, the common electrode CE is electrically connected to the power supply lines PL2 for every pixel PX, and the power supply lines PL2 for supplying power to the common electrode CE are located below the pixel electrodes PE. Accordingly, the second embodiment is free from potential variations in the common electrode CE, and can realize brighter display and/or a longer lifetime than in the case where the power supply lines PL2 and pixel electrode PE are formed on the same layer.

Furthermore, in the display panel DP of the second embodiment, intermediate electrodes IE are arranged on the insulating layer I2 at positions corresponding to the through-holes TH1 and spaced apart from the pixel electrodes PE, and are connected to the power supply lines PL2 at positions of the through-holes TH1. Also, the through-holes TH2 are formed in the partition insulating layer SI at positions that correspond to the intermediate electrodes IE and are displaced from the respective through-holes TH1 in an in-plane direction. The common electrode CE is connected to the intermediate electrodes IE at the positions of the through-holes TH2.

The structure in which through-holes are formed at different positions in the in-plane direction does not easily cause a discontinuous portion to be included in the common electrode CE in the through-holes TH1 or TH2, which is advantageous in realizing high yield.

In the second embodiment, the intermediate electrode IE and pixel electrode PE may be made of different materials or the same material. If they are made of the same material, they can be formed in the same process.

In the first and second embodiments, the common electrode CE and power supply lines PL2 are connected for every pixel PX. However, they may be connected for every plural pixels PX.

FIG. 7 is a plan view schematically showing an example of a structure which may be employed in the display panel according to the second embodiment. FIG. 7 only shows the pixel electrodes PE, intermediate electrode IE, scan signal lines SL, video signal lines DL, and power supply lines PL1 and PL2, and does not show the other elements. Further, in FIG. 7, reference symbols PEG, PEB and PER denote pixel electrodes PE of the organic EL elements OLED that emit light of green, blue and red, respectively.

In general, the organic EL elements OLED that emit light of blue and red have lower emission efficiencies than the organic EL element OLED that emits light of green. To acquire sufficient luminance, the organic EL elements OLED that emit light of blue and red are powered by a higher current density than the organic EL element OLED that emits light of green. For this reason, the former organic EL elements will be more easily degraded than the latter organic EL element.

In the structure of FIG. 7, the intermediate electrodes IE are arranged only in the columns of the pixel electrodes PEG. Moreover, in this structure, the pixel electrodes PEG are made smaller than the pixel electrodes PEB and PER. This being so, lifetimes of the organic EL elements OLED that emit light of blue and red do not be shortened by the intermediate electrodes IE.

Note that the structure of FIG. 7 is also applicable to the display panel of the first embodiment if the manner of connection between the power supply lines PL2 and the common electrode CE is changed.

When the common electrode CE is connected to the power supply lines PL2 for every plural pixels PX, their connections may be arranged regularly or randomly. However, it can be designed more easily to arrange their connections regularly than to arrange them randomly.

In the first and second embodiments, only in the display area AA, the power supply lines PL2 are connected to the common electrode CE. They may be connected in both the display area AA and its peripheral area.

Also, the first and second embodiments employ the pixel circuit shown in FIG. 1. However, the invention is not limited to this. It is sufficient if an active matrix driving is possible. For instance, the drive control element DR and/or the switch SW may be an n-channel TFT. Further, the capacitor C may be connected between the control terminal of the drive control element DR and one of the power supply line PL2 and the pixel electrode PE. In addition, a pixel circuit utilizing a current signal as a video signal may be used instead of the pixel circuit utilizing a voltage signal as a video signal.

In the first and second embodiments, each power supply line PL2 is set at a lower potential than each power supply line PL1. Alternatively, the former may be set at a higher potential than the latter.

In the first and second embodiment, the pixel electrodes PE are light-reflective. Alternatively, the pixel electrodes PE may be light-transmissible. In this case, a reflective layer may be located on the back side of each pixel electrode PE.

In the first and second embodiments, the pixel electrodes PE are used as anodes, and the common electrode CE is used as a cathode. Alternatively, the pixel electrodes PE may be used as cathodes, and the common electrode CE be used as an anode. When the front electrode is made of, for example, a metal material, it is formed into a thin film so that it is light-transmissible. For instance, when the common electrode CE is used as a cathode, it may have an Ag/ITO lamination structure.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display comprising:
an insulating substrate;
an auxiliary line disposed on a main surface of the insulating substrate;
an insulating underlayer covering the auxiliary line and the main surface of the insulating substrate and provided with a first through-hole which communicates with the auxiliary line;
pixel electrodes disposed on the insulating underlayer and surrounding an opening of the first through-hole;
photo-active layers each covering the pixel electrode and each including a light-emission layer; and
a light-transmissive common electrode covering the photo-active layers and electrically connected to the auxiliary line via the first through-hole.

2. The display according to claim 1, further comprising a partition insulating layer covering the insulating underlayer at a position between the pixel electrodes and provided with a second through-hole, wherein the common electrode further covers the partition insulating layer, and wherein the common electrode is electrically connected to the auxiliary line via the first and second through-holes.

3. The display according to claim 2, wherein the second through-hole communicates with the first through-hole, and wherein an opening of the second through-hole on a side of the insulating underlayer is larger than the opening of the first through-hole on a side of the partition insulating layer.

4. The display according to claim 3, wherein the first and second through-holes are forward-tapered.

5. The display according to claim 2, further comprising an intermediate electrode interposed between the insulating underlayer and the partition insulating layer and electrically connected to the auxiliary line via the first through-hole, wherein the common electrode is electrically connected to the intermediate electrode via the second through-hole.

6. The display according to claim 5, wherein a material of the intermediate electrode and a material of the pixel electrodes are equal to each other.

7. The display according to claim 1, further comprising a video signal line interposed between the insulating substrate and the insulating underlayer, a material of the video signal line and a material of the auxiliary line being equal to each other.

8. The display according to claim 1, wherein the pixel electrode faces the auxiliary line.

9. The display according to claim 1, wherein the display is a top emission organic EL display.

10. The display according to claim 9, further comprising:
a power supply line interposed between the insulating substrate and the insulating underlayer;
scan signal lines interposed between the insulating substrate and the insulating underlayer;
video signal lines interposed between the insulating substrate and the insulating underlayer and intersecting the scan signal lines; and
pixel circuits each interposed between the insulating substrate and the insulating underlayer at a position near an intersection of the scan signal line and the video signal line and each electrically connected between the pixel electrode and the power supply line.

11. An array substrate comprising:
an insulating substrate;
an auxiliary line disposed on a main surface of the insulating substrate;
an insulating underlayer covering the auxiliary line and the main surface of the insulating substrate and provided with a first through-hole which communicates with the auxiliary line;
pixel electrodes disposed on the insulating underlayer and surrounding an opening of the first through-hole.

12. The array substrate according to claim 11, further comprising a partition insulating layer covering the insulating underlayer at a position between the pixel electrodes and provided with a second through-hole, wherein the second through-hole communicates with the first through-hole, and wherein an opening of the second through-hole on a side of the insulating underlayer is larger than the opening of the first through-hole on a side of the partition insulating layer.

13. The array substrate according to claim 12, wherein the first and second through-holes are forward-tapered.

14. The array substrate according to claim 11, further comprising:
a partition insulating layer covering the insulating underlayer at a position between the pixel electrodes and provided with a second through-hole; and
an intermediate electrode interposed between the insulating underlayer and the partition insulating layer and electrically connected to the auxiliary line via the first through-hole,
wherein the second through-hole communicates with the intermediate electrode.

15. The array substrate according to claim 14, wherein a material of the intermediate electrode and a material of the pixel electrodes are equal to each other.

16. The array substrate according to claim 11, further comprising a video signal line interposed between the insulating substrate and the insulating underlayer, a material of the video signal line and a material of the auxiliary line being equal to each other.

17. The array substrate according to claim 11, wherein the pixel electrode faces the auxiliary line.

18. The array substrate according to claim 11, further comprising:
a power supply line interposed between the insulating substrate and the insulating underlayer;
scan signal lines interposed between the insulating substrate and the insulating underlayer;
video signal lines interposed between the insulating substrate and the insulating underlayer and intersecting the scan signal lines; and
pixel circuits each interposed between the insulating substrate and the insulating underlayer at a position near an intersection of the scan signal line and the video signal line and each electrically connected between the pixel electrode and the power supply line.
